(19) United States
(12) Patent Application Publication
(10) Pub. No.: US 2020/0207663 A1
(43) Pub. Date: Jul. 2, 2020

(54) CELLULOSE FILAMENTS REINFORCED CEMENT COMPOSITE BOARD AND METHOD FOR THE MANUFACTURE OF THE SAME

(71) Applicant: FPInnovations, Pointe-Claire (CA)

(72) Inventors: Xiaolin CAI, Kirkland (CA); Yuxia BEN, Kirkland (CA); Xujun HUA, Kirkland (CA); Michelle RICARD, Pointe-des-Cascades (CA); Carole LAROUCHE, Châteauguay (CA); Xiang-Ming WANG, Québec (CA)

(73) Assignee: FPInnovations, Pointe-Claire, QC (CA)

(21) Appl. No.: 16/614,851

(22) PCT Filed: May 18, 2018
(86) PCT No.: PCT/CA2018/050586

§ 371 Date: Nov. 19, 2019

Related U.S. Application Data
(60) Provisional application No. 62/508,545, filed on May 19, 2017.

(51) Int. Cl. C04B 16/02; B28B 1/52; B28B 11/24; C04B 28/04

(52) U.S. Cl. CPC C04B 16/02; C04B 28/04; B28B 11/24; B28B 1/525

(57) ABSTRACT

Cement composite boards comprising cellulose filaments (CF) and/or CF-containing pulp, are described. The composite boards have at least an improved modulus of rupture when compared with similar board that are free of CF. Methods for producing the CF and/or CF-containing pulp reinforced cement boards are also described. The CF cement composite board comprises: cellulose filaments (CF) and/or CF-containing pulp, and cement, wherein the CF has an aspect ratio of 200 to 5000, comprising a weight % of CF is from 1% to 20% by weight of the composite board. The composite boards herein described may have a modulus of rupture of more than 7 MPa.

### CROSS-REFERENCE TO RELATED APPLICATIONS

The present application claims benefit of U.S. Provisional Application No. 62/508,545 filed May 19, 2017, the content of which is hereby incorporated by reference in their entirety.

### FIELD

This description relates to cement composite boards comprising cellulose filaments (CF) and/or CF-containing pulp, having at least an improved modulus of rupture; and the methods for producing the CF and/or CF-containing pulp reinforced cement boards.

### BACKGROUND

It is known in the building and construction industry that fiber cement boards, also referred to as fiber cement board composites, comprise inorganic and/or organic fibers to improve several desirable properties such as mechanical strength, durability, and long term crack control of the board products.

Fiber cement boards are typically constituted by sand, cement, reinforcement fibers, and additives. Fiber cement boards can be used for external and internal applications such as siding/cladding, fencing, decorative panels, fire & acoustic walls, non-pressure pipes, internal lining, flooring and underlayment. Historically, asbestos fibers were the most widely used fibers to manufacture fiber cement board for over 120 years. However, due to the health concern of asbestos fibers since the early 1970s, the construction industry has been trying to develop alternative solutions to replace the asbestos fibers used in fiber cement boards. Cellulose fibers or a combination of cellulose fibers and synthetic fibers such as polyvinyl alcohol (PVA) are the major alternatives on the current market to replace the asbestos fibers in fiber cement boards. Unfortunately, none of the alternative fibers are as good as asbestos fibers in terms of performance and cost competitiveness.

Conventional cellulose fiber cement board composites are typically constituted by crystalline silica (quartz, 30-50%), calcium silicate (hydrate, 35-65%), calcium carbonate (<30%), calcium aluminum silicate (hydrate, <20%), cellulose fibers (<20%), synthetic fibers (<10%), and additives (<10%) such as viscosity modifiers, fire retardants, water proof agents, and thickeners, as described in U.S. Pat. Nos. 4,985,119, 6,676,745, 6,872,246, 7,727,329, 7,942,964, and 7,976,626. Some of the major drawbacks of the presence of cellulose fibers such as wood pulp fibers in fiber cement boards are the relatively low physical strength, water permeability and water migration ability, and low freeze-thaw resistance due to the porous structure of wood pulp fibers. The lumens and cell walls of wood pulp fibers exhibit water absorption capacity and facilitate water transportation throughout the fiber cement board composites, which affect the long term durability and the performance of the composites in certain environments.

Conventional fiber cement composite board are mostly produced by the Hatschek dewatering process (on a modified sieve cylinder paper making machine). Other processes, such as casting, molding, filter pressing, extrusion, injection molding, Mazza pipe process, Magnani process are also used to make specialty products as described in U.S. Pat. Nos. 6,676,745; 7,942,964; 7,976,626 and 8,133,352. Known Hatschek methods for producing a fiber cement board comprise a modified paper-making sieve cylinder machine, on which a diluted aqueous slurry of fibers, fine sand, additives and cement is dewatered to form a wet sheet of about 0.3 mm in thickness. The sieve cylinder machine requires fibers to form a network to catch the solid cement (or silica) particles. One of the major problems of synthetic fibers is their inability of filtration, which makes it impossible to retain the cement particles. Another issue associated with synthetic fibers, for example, PVA, is their low glass transition temperatures which make it difficult to resist the high temperature of the autoclave curing step.

The final fiber cement composite boards obtained in the above-mentioned processes are typically air-cured if synthetic fibers are used in the formulation, or autoclave cured if only cellulose fibers are used in the formulation (U.S. Pat. Nos. 6,872,246 and 7,148,270). Generally, a wide variety of cellulose fibers and/or synthetic fibers can be used for the preparation of the cement slurry to form the fiber cement board (U.S. Pat. Nos. 8,133,352; 8,241,419; 8,333,836 and 8,791,178).

There have been some attempts to strengthen fiber cement composite boards with the addition of nanocrystalline cellulose. For example, Thomson et al. (U.S. Pat. No. 8,273,174) disclosed a fiber cement board product incorporating nanocrystalline cellulose and cellulose fibers. However, the modulus of modulus (MOR) was improved by only 10% from the addition of up to 3% of nanocrystalline cellulose and the moisture absorption was reduced by only 1%.

Mohammadkazemi et al. (2015, Construction and Building Materials 101: 958-964) studied the potential of using bacterial nano-cellulose (BNC) to reinforce fiber cement composite boards. It was found that the maximum hydration temperature of bacterial nanocellulose reinforced fiber-cement boards was improved, but the mechanical performance improvement was limited. The major drawbacks of using nanocrystalline cellulose and bacterial nanocellulose are the high cost associated with these cellulose nanomaterials, and the limited improvement of performance of the board products due to the low aspect ratio of these cellulose nanomaterials. Therefore, these nanocellulose materials are unsuitable for the production of commercial fiber cement boards.

Japanese patent No. JP 2013-188864 described a method to add cellulose nanofibers into highly concentrated concrete paste using a dry injection moulding process. To help the dispersion of the nanofibers in the cement molded body, support medium powder was introduced to carry the nanofibers, where the ratio of nanofibers to support medium powder varied from 3.33-6.67%, and organic solvents such as an alcohol were utilized to help the dispersion of the nanofibers into the dry cement molding mix. The amount of nanofibers in the final mixture of cement molded body was less than 1% and the preferable amount of nanofibers was around 0.1% in mass. The aspect ratio of the nanofibers in this patent was around 100. It was shown that the mechanical strength of the dry mixed molding of final concrete was improved by only ˜14% by adding the nanofibers into the formulation.

U.S. Pat. No. 9,174,873 described a method of using microfibrillar cellulose as additives for concrete admixtures. The function of microfibrillar cellulose in the concrete admixtures was to modify the rheology or control the segregation of cementitious composition admixtures to influence the wet formulations. The water to cement ratio in these admixtures ranged from 0.35 to 1.0. The amount of microfibrillar cellulose was between 0.002% and 0.2% by weight of the cementitious binder in the cementitious composition, and water was added in the composition optionally.

In summary, several attempts of using different cellulose micro- and nanomaterials to reinforce fiber cement boards have been made, with very limited success as they produced low performance improvements. There is a continuing need to find alternatives for the production of reinforced cement boards having improved mechanical properties to suitably to improve the cellulose fiber cement board which replaced asbestos fibers in terms of performance and costs competitiveness.

### SUMMARY

In accordance with one embodiment of the present disclosure, there is provided a CF cement composite board comprising: cellulose filaments (CF) and/or CF-containing pulp, and cement, wherein the CF has an aspect ratio of 200 to 5000 comprising a weight % of CF is from 1% to 20% by weight of the composite board.

In accordance with another embodiment of the present disclosure, there is provided the CF cement composite board herein described, wherein the CF has a width from 30 nm to 500 nm.

In accordance with another embodiment of the present disclosure, there is provided the CF cement composite board herein described wherein the weight % of CF is from 1 to 7% by weight of the composite board.

In accordance with another embodiment of the present disclosure, there is provided the CF cement composite board herein described wherein the weight % of the CF is from 2 to 4.5% by weight of the composite board.

In accordance with another embodiment of the present disclosure, there is provided the CF cement composite board herein described, wherein the CF is at least one of a free of chemicals form, a free of chemical modification form, a free of derivatization form.

In accordance with another embodiment of the present disclosure, there is provided the CF cement composite board herein described wherein the CF are dry cellulose filaments that are re-dispersible in water.

In accordance with another embodiment of the present disclosure, there is provided the CF cement composite board herein described wherein the dry cellulose filaments are at least 80% by weight solids.

In accordance with another embodiment of the present disclosure, there is provided the CF cement composite board herein described, wherein the dry cellulose filaments are at least one of a dry lap, flakes or particles.

In accordance with another embodiment of the present disclosure, there is provided the CF cement composite board herein described, wherein the CF and/or CF-containing pulp are selected from the group consisting of CF and/or CF-containing pulp in a never-dried wet state, in an aqueous slurry and mixtures thereof.

In accordance with another embodiment of the present disclosure, there is provided the CF cement composite board herein described, further comprising cellulose fibers and/or synthetic fibers.

In accordance with another embodiment of the present disclosure, there is provided the CF cement composite board herein described, further comprising from 1% to 20% of cellulose fibers by weight.

In accordance with another embodiment of the present disclosure, there is provided the CF cement composite board herein described, wherein the CF cement board has a density of 0.5 g/cm3 to 2.0 g/cm3.

In accordance with another embodiment of the present disclosure, there is provided the CF cement composite board herein described, further comprising silicate aggregates.

In accordance with another embodiment of the present disclosure, there is provided the CF cement composite board herein described, further comprising additives.

In accordance with another embodiment of the present disclosure, there is provided a CF cement composite board comprising: a cellulose filaments (CF)-containing pulp, and cement, wherein the CF has an aspect ratio of 200 to 5000, comprising a weight % of CF from 1% to 20% by weight of the composite board.

In accordance with another embodiment of the present disclosure, there is provided the CF cement composite board herein described, wherein the CF has a width from 30 nm to 500 nm.

In accordance with another embodiment of the present disclosure, there is provided the CF cement composite board herein described, wherein the weight % of the CF is from 2 to 4.5% by weight of the composite board.

In accordance with another embodiment of the present disclosure, there is provided the CF cement composite board herein described, wherein the CF is at least one of a free of chemicals form, a free of chemical modification form, a free of derivatization form.

In accordance with another embodiment of the present disclosure, there is provided the CF cement composite board herein described, wherein the CF and/or CF-containing pulp are selected from the group consisting of CF and/or CF-containing pulp in a never-dried wet state, in an aqueous slurry and mixtures thereof.

In accordance with another embodiment of the present disclosure, there is provided the CF cement composite board herein described, further comprising cellulose fibers and/or synthetic fibers.

In accordance with another embodiment of the present disclosure, there is provided the CF cement composite board herein described, further comprising from 1% to 20% of cellulose fibers by weight.

In another embodiment, it is provided a cellulose filament (CF) cement slurry comprising CF and/or CF-containing pulp, and cement, wherein the CF has an aspect ratio of 200 to 5000, the slurry comprises a total solid content of about 2% (w/w) to about 30% (w/w) and comprises a weight % of CF from 1% to 20% by weight of the slurry.

In yet another embodiment, the present disclosure provides a method for preparing a CF cement board, the method comprising the steps of: forming an aqueous slurry comprising CF and/or CF-containing pulp, cement, and water, and optionally pulp fibers, synthetic fibers, sand and/or additives; filtering the aqueous slurry to form a thin sheet; optionally laminating two or more than two wet sheets to give a cement board with a desired thickness; pressing the wet board to a desired shape and/or form; and autoclave-curing the pressed cement board, or air-curing the pressed cement board if synthetic fibers are added.

In accordance with still another aspect of the present disclosure, herein is provided a method for preparing a CF cement board, the method comprising the steps of: forming an aqueous slurry comprising CF, and/or CF-containing pulp, cement, and water, and optionally pulp fibers and/or synthetic fibers, sand, and/or additives; filtering the aqueous slurry to form a thick panel; pressing the wet panel to a desired shape and/or form; and autoclave-curing the pressed CF cement board, or air-curing the pressed CF cement board if synthetic fibers are added.

In accordance with still another aspect of the method herein described, the press molded mat obtained by pressing the wet mat is hardened at room temperature (˜23° C.) for 24 hours and cured in an autoclave. Curing in an autoclave is preferably effected by raising the temperature to 120-180° C. over 2-3.5 hours, keeping the temperature for 6 to 8 hours before releasing the pressure.

In accordance with another aspect of the method herein described, the curing step comprises drying the wet pressed material in a conditioned room at room temperature (˜23° C.) and 90-100% relative humidity (RH) for up to 28 days.

### BRIEF DESCRIPTION OF THE DRAWINGS

Reference will now be made to the accompanying drawings.

FIG. 1A is an electron scanning micrograph that shows the morphology of, a reference cement board containing 8% cellulose fibers which shows limited bonding between cellulose fibers and cement particles;

FIG. 1B is an electron scanning micrograph that shows the morphology of CF cement composite board containing a mixture of CF and cellulose fibers, showing greater bonding between CF and cellulose fibers, CF and cement particles;

FIG. 1C is an electron scanning micrograph that shows the morphology CF cement board containing CF, cement and sand showing excellent bonding between CF and cement particles;

FIG. 1D is an electron scanning micrograph that shows the morphology CF cement board containing CF, PVA fiber, cement and sand showing excellent bonding between CF, CF and PVA fibers, CF and cement particles;

FIG. 2A is a photograph of mixer with a dilute aqueous slurry for a CF cement composite board according to one embodiment herein described;

FIG. 2(b) is a photograph of a laboratory vacuum dewatering process for the dilute aqueous slurry of CF cement; in a vacuum dewatering system;

FIG. 3(a) is a photograph of a wet CF cement composite sheet according to one embodiment herein described;

FIG. 3(b) is a photograph of a dry CF cement composite board according to one embodiment herein described; and

FIG. 4 is a photograph of dry CF cement composite board used for flexural testing.

### DETAILED DESCRIPTION

The present description discloses the incorporation of specific nanosized, ribbon-like cellulose filament (CF) into a cement composite board comprising CF and/or CF-containing pulp that provides improved mechanical properties. Furthermore, the present description discloses methods and formulations of making CF cement composite boards comprising CF and/or CF-containing pulp in very dilute aqueous slurries using a dewatering process.

Unless otherwise indicated, the definitions and embodiments described in this and other sections are intended to be applicable to all embodiments and aspects of the present disclosure herein described for which they are suitable as would be understood by a person skilled in the art.

As used in the present disclosure, the singular forms “a”, “an” and “the” include plural references unless the content clearly dictates otherwise. For example, an embodiment including “a board” should be understood to present certain aspects with one board, or two or more additional boards.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “about” and “approximately” as used herein mean a reasonable amount of deviation of the modified term such that the end result is not significantly changed. These terms of degree should be construed as including a deviation of at least ±5% or at least ±10% of the modified term if this deviation would not negate the meaning of the word it modifies.

Cellulose filaments (CF) previously referred to as cellulose nanofilaments (CNF) have interesting properties, one of which is increasing the dry and wet strength properties of paper when used as an additive in the production thereof. They are produced by multi-pass, high consistency refining of wood or other plant fibers at a high level of specific energy using high consistency refiners (see U.S. Pat. No. 9,051,684). They have reinforcement ability over that of cellulose microfibrils or nanofibrils such as microfibrillated cellulose (MFC) (also known as microfibrillar cellulose) or nanofibrillated cellulose (NFC) prepared using other methods for the mechanical fibrillation of wood pulp fibers. This is likely due to the longer lengths and higher aspect ratio of CF that results from the unique multi-pass and high consistency production process which minimizes fiber cutting.

CF-containing pulp utilized in making the CF cement board composites herein disclosed refers to CF dried with pulp fibers as a carrier medium as described in document US2016/0319482 incorporated herein by reference, teaches a method to produce dry and water re-dispersible CF using pulp fibers as a carrier medium. The CF has the same characteristics as those of the never-dried CF described in U.S. Pat. No. 9,051,684. The never-dried CF contains up to 70% of water, which poses problems of high transportation costs and a risk of losing its properties over storage time. The CF dried with a carrier pulp taught in US2016/0319482 can be easily stored and have prolonged shelf life and be easily dispersed in water to gain the CF reinforcement ability fully.

The term “cellulose filaments” or “CF” and the like as used herein refers to filaments obtained from cellulose fibers having a high aspect ratio, for example, an average aspect ratio of at least about 200, preferably an average aspect ratio of from about 200 to about 5000; an average width in the nanometer range, preferably an average width of from about 30 nm to about 500 nm; and an average length in the micrometer to millimeter range, for example, an average length of from about 100 μm to about 2 mm. The cellulose filaments used herein are obtained from a process which uses mechanical means only, such as the method disclosed in the U.S. Pat. No. 9,051,684. These cellulose filaments are, for example, under proper mixing conditions, dispersible in water or in aqueous slurries of minerals such as those used in the preparation of CF cement boards. Such cellulose filaments can also be obtained by mechanical disintegration of dry films of cellulose filaments prepared using a method disclosed in Canadian Patent No. 2,889,991. The dry cellulose filaments of this process are re-dispersible in water or in aqueous slurries of minerals such as those used in the preparation of CF cement boards. Importantly, the cellulose filaments are dry at least 80% by weight solids preferably at least 90% by weight solids and most preferably at least 99% by weight solids. The cellulose fibers from which the cellulose filaments are obtained can be, but are not limited to, kraft pulp fibers such as Northern Bleached Softwood Kraft (NBSK). Other kinds of suitable fibers are also applicable, the selection of which can be made by a person skilled in the art. The term “cellulose filaments” or “CF” used herein includes those produced in the wet form at a consistency between 20% -60% and transported in such a wet form using an impervious bag. It also includes dry rolls of or shredded films of cellulose filaments made on paper machines as described in Canadian Patent No. 2,889,991. CF-containing pulp refers to the dry and water re-dispersible mixture of CF and pulp fibers described in Patent Application US2016/0319482.

CF-containing pulp utilized in making the CF cement board composites herein disclosed refers to CF dried with pulp fibers as a carrier medium as described in document US2016/0319482, teaches a method to produce dry and water re-dispersible CF using pulp fibers as a carrier medium. The CF can have the characteristics as those of the never-dried CF described in U.S. Pat. No. 9,051,684. The never-dried CF contains up to 70% of water, which poses problems of high transportation costs and a risk of losing its properties over storage time. The CF dried with a carrier pulp taught in US2016/0319482 can be easily stored and have prolonged shelf life and be easily dispersed in water to gain the CF reinforcement ability fully.

The expressions “CF cement composite boards” or “CF cement boards” are used interchangeably herein and refer to and define a board that comprises cement, and CF and/or CF-containing pulp, and optionally aggregates, such as fine silicate sand. The CF cement composite boards can be used for various purposes, i.e. structural purposes and/or decorative purposes.

The term “cement”, preferably refers to Portland cement in a preferred embodiment. However “cement” may also be: high alumina cement, lime cement, kiln dust cement, high phosphate cement, and ground granulated blast furnace slag cement and mixtures thereof.

The term “aggregates”, preferably refers to fine ground silicate sand, but it also includes, and is not limited to, any other type of silicate, clays, metal oxides or hydroxides, or mixtures thereof.

The CF cement board herein described may also include organic and/or inorganic density modifiers with a density of less than about 1.5 g/cm³. The density modifiers can be natural or synthetic materials.

The CF cement board of the present disclosure includes also additives. The term “additives” can include, but are not limited to, the afore-mentioned density modifiers, water-soluble resins that serve as binders in the CF reinforced cement products, fire retardants, strength aids, polymer emulsions, water resistant agents, viscosity modifiers, pigments forming agents, plasticizers, or mixtures thereof.

The CF cement board of the present disclosure also includes cellulose fibers and/or synthetic fibers. The cellulose fibers include but are not limited to pulp fibers. The pulp fibers can be made from softwood, hardwood, agricultural raw materials, recycled waste paper or any other forms of lignocellulosic materials. The pulp fibers can be made by various pulping methods, such as chemical, mechanical, thermal, biological pulping methods, or by combinations of these treatments. The term “synthetic fibers” preferably refers to PVA fibers, but it also includes and is not limited to, any other types of synthetic fibers.

It is thus provided novel CF and/or CF-containing pulp reinforced cement composite boards, the formulations and the methods of manufacturing the CF cement boards.

The present disclosure relates to novel CF cement boards, wherein the novel fibrous materials correspond to CF and/or CF-containing pulp. The said cellulose filaments have an aspect ratio of at least 200 to about 5000, and they are in the forms free of chemicals, chemical modification or derivatization. The CF or CF-containing pulp may be provided in a never-dried state, in aqueous slurry, or in a dry state such as dry lap, flake, or particles.

The CF cement boards according to the present disclosure comprise cement, CF and/or CF-containing pulp, and/or silicate sand (aggregates). The cement acts as a binder, providing stiffness and compression strength. The cement ratio can be varied from 20-92%, preferably at the range of 20-45%. The siliceous component provides stiffness, strength and water resistance performance. The silicate component ratio is ranged from 30-65%, preferably in the range of 45-55%. The CF and/or CF-containing pulp, alone or in combination with pulp fibers and/or synthetic fibers, forms the network on the sieve that catches the solid particles in the dewatering process of making the CF cement boards. The CF and/or CF-containing pulp ratio is in the range of 1-20%, preferably in the range of 2-12%. Other additives in small quantities (5%)and/or such as water-soluble resins, density modifiers, fire retardants, strength aids, polymer emulsions, water resistant agents, viscosity modifiers, pigments, forming agents, plasticizers are usually added to the CF cement board formulations during the manufacturing process.

In accordance with one aspect of the present disclosure, CF cement boards can be produced by adding only CF and water to the cement.

In accordance with one aspect of the present disclosure, CF cement boards can be produced by adding only CF, and water to the mixture of cement and sand.

In accordance with another aspect of the present disclosure, the CF cement boards can comprise from about 1% up to 20% of CF without or with about 1% up to 20% of cellulose fibers by weight, based on the total weight of the CF, cement, sand and additives.

In accordance with a further aspect of the present disclosure, the CF cement boards can have a density of about 0.5 g/cm³ to about 2.0 g/cm³, preferably about 0.7 g/cm³ to about 1.5 g/cm³.

In accordance with still another aspect of the present disclosure, the CF cement boards can have a thickness of about ¼ inch (about 6.4 mm) to 1 inch (about 25.4 mm), a width of about 4 inch (about 101.6 mm) to about 8 feet (about 244 cm), and a length of about 4 feet (about 122 cm) to about 12 feet (about 366 cm).

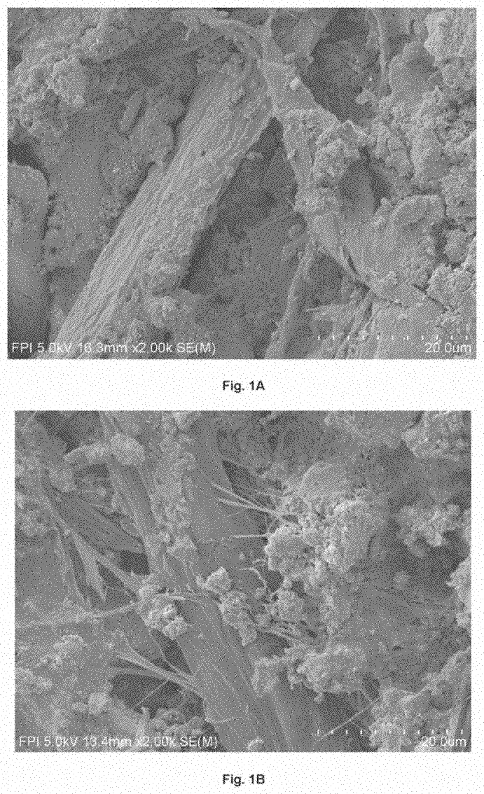

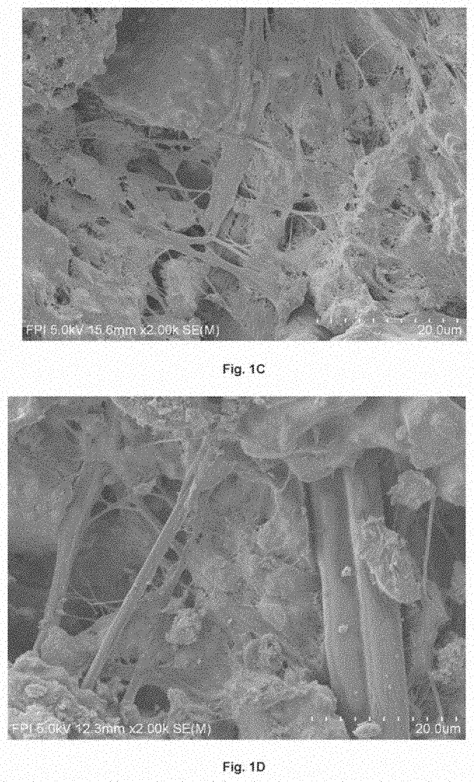

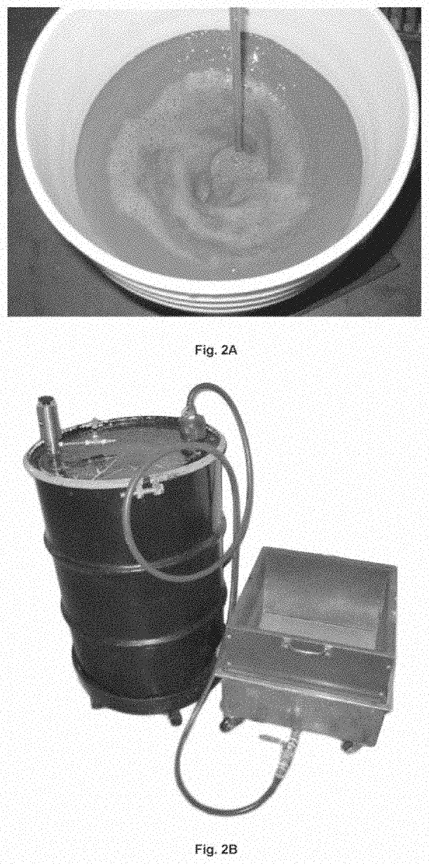

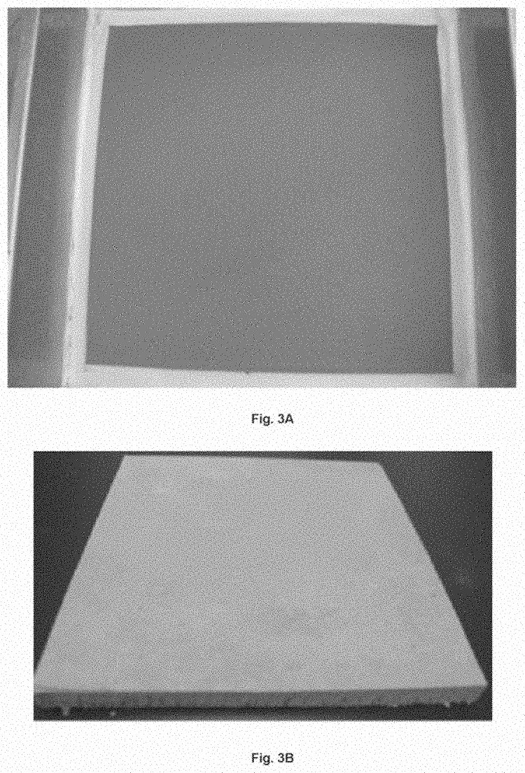

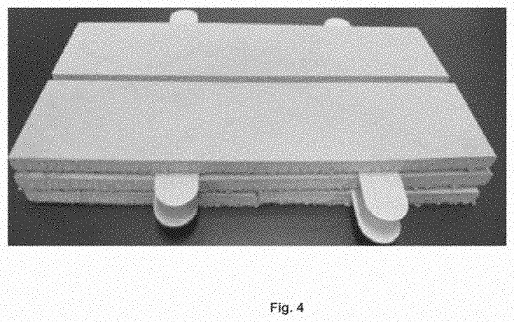

Unexpectedly, the resulting CF cement boards of the present disclosure have a significantly improved Modulus of Rupture (MOR), wherein the MOR is almost doubled with the addition of 2%-4% CF into the cement board formulation, when compared to a cement board produced with conventional cellulose fibers. Thus, CF provides better and stronger bonding amongst the particles due to the higher aspect ratio and the much more numerous bonding points, which can be observed clearly in FIG. 1 (B, C, D), compared to those of the conventional cellulose fibers (FIG. 1A) at the same amount of cellulose fibrous mass.

Also unexpectedly, the resulting CF cement boards of the present disclosure have a significantly improved Modulus of Elasticity (MOE), when compared to cement board produced with a combination of conventional cellulose fibers and synthetic fibers.

Surprisingly, the presence of a water absorbent material such as CF does not increase the absorption of water of the cement board comprising CF at certain concentrations when compared with a cement board reinforced with conventional cellulose fibers.

The current disclosure is also effective in solving one of the key problems of synthetic fibers reinforced cement boards by providing filtration and assistance in capturing cement particles during the manufacturing of the boards, and by reducing water permeability in the final products.

In accordance with another embodiment herein described, there is provided a dilute aqueous slurry formulation suitable to produce a CF and/or CF-containing pulp reinforced cement board by dewatering processes.

In accordance with another aspect of the present disclosure, the aqueous slurry comprising CF and/or CF-containing pulp, cement, silicate sand, cellulose fibers and/or synthetic fibers, and additives can have a total solid content of 2% (w/w) to about 30% (w/w). Preferably, the aqueous slurry comprising CF and/or CF-containing pulp, cement, silicate sand, cellulose fibers and/or synthetic fibers, and additives can have a total solid content of 2% (w/w) to about 20% (w/w). More preferably, the aqueous slurry comprising CF and/or CF-containing pulp, cement, silicate sand, cellulose fibers and/or synthetic fibers, and additives can have a total solid content of 2% (w/w) to about 10% (w/w).

In accordance with another embodiment, there is provided a dilute aqueous slurry formulation wherein the ratio of water to cement in the formulation of said slurry is 98/2 to 70/30(w/w), more preferably in the range of 98/2- 80/20 (w/w), most preferably in the range of 98/2- 90/10 (w/w).

In accordance with another embodiment, there is provided a dilute aqueous slurry formulation wherein the amount of CF in the solid components of CF and/or CF-containing pulp, cement, sand, cellulose fibers and/or synthetic fibers, and additives is in the range of from 1-20% (w/w).

In accordance with another aspect of the present disclosure, the dilute aqueous slurry formulation comprising CF and/or CF-containing pulp, cement, silicate sand, additives, and optionally cellulose fibers and/or synthetic fibers can be a mixture of two or optionally three separated slurries, wherein the first slurry can be obtained by dispersing CF, and/or CF-containing pulp in water to obtain fully or substantially dispersed CF, the second slurry can be obtained by mixing cement, sand, water and additives, and optionally the third slurry can be obtained by dispersing cellulose fibers and/or synthetic fibers. According to another aspect of the present disclosure, a disintegrator, pulper, blender, high speed mixer or other mixing equipment can be used to disperse the CF and/or CF-containing pulp. In a preferred embodiment, a pulper can be used to disperse the CF and/or CF-containing pulp.

In accordance with another aspect of the present disclosure herein described, the first slurry of the formulation can have a consistency of up to about 10% (w/w). More preferably, the first slurry of the formulation can have a consistency of about 4-8% (w/w).

In accordance with another aspect of the present disclosure herein described, a CF and/or CF-containing pulp are utilized. The said CF have an aspect ratio of 200 to 5000. The CF or CF-containing pulp may be utilized in a variety of states particularly as in a never-dried state, in aqueous slurry, or in a dry state such as dry lap, flake, or particles.

In accordance with another aspect of the present disclosure, the CF-containing pulp can have a CF/carrier pulp weight ratio of about 1/99 (w/w) to about 50/50 (w/w).

In accordance with yet another aspect of the present disclosure, the CF-containing pulp can be added alone to the formulation of the slurry to make the CF cement board and/or mix with regular cellulose fibers to make the CF cement board.

According to yet another aspect of the present disclosure, the second slurry and optionally the third slurry of the formulation can have a consistency of 1% to about 30% (w/w), preferably 2-20% (w/w).

In accordance with another aspect of the disclosure herein described, the two or optionally three dilute slurries are mixed together prior to dewatering.

In accordance with still another aspect of the present disclosure, the ratio of CF to cement in the aqueous slurry comprising CF and cement can be from about 1/99 (w/w) to about 50/50 (w/w).

In a further aspect of the present disclosure, in the formulations herein described one of the additives is a water-soluble resin selected from a group comprising polyvinyl alcohols, carboxymethyl cellulose, methyl cellulose, polyethylene oxides and polyvinyl ethers. The water-soluble resin can be added to the aqueous slurry comprising CF, cement and silicate sand prior to filtering the aqueous slurry through the screen. The water-soluble resin serves as a binder in the CF reinforced cement products, further enhance adhesion among the layers of the components contained in the products, and improve the binding strength, as well as freezing and fusion resistance of the products.

In accordance with one embodiment herein described, there is provided a method to produce CF and/or CF-containing pulp reinforced cement board using a dewatering process followed by the use of an autoclave curing or air curing process.

The method comprises (i) preparing a dispersed CF suspension comprising CF and/or CF-containing pulp, and optionally pulp fibers and/or synthetic fibers (ii) preparing a dilute aqueous slurry of cement, silicate sand, and additives, (iii) mixing the dispersed CF and/or CF-containing pulp suspension of step (i) into the aqueous slurry comprising cement, silicate sand, and/or additives of step (ii), (iv) filtering the mixed slurry in a dewatering device, (v) removing the water by opening the vacuum dewatering valve to produce a wet CF cement sheet and optionally overlapping two or more than two said wet CF cement sheets, (vi) pressing the wet CF cement sheet or the wet overlapped CF cement sheets to remove majority of the water and to control the thickness of the resulting CF cement board, and (vii) curing and drying the CF cement board in an autoclave, or curing and air-drying the CF cement board under a controlled condition.

In accordance with another embodiment, there is provided the method herein described, wherein the never-dried CF, CF film or CF-containing pulp is well dispersed to form a CF suspension using the dispersion method described in patents of WO 2012/097446, WO2014071523 A1, or US2016/0319482 A1.

In accordance with another embodiment, there is provided the method herein described, wherein the dilute aqueous slurry of cement and silicate sand without or with additives is prepared and well mixed.

In accordance with another embodiment, there is provided the method herein described, wherein the dispersed CF and/or CF-containing pulp suspension, and optionally dispersed cellulose fibers and/or synthetic fibers, is mixed with the aqueous slurry comprising cement and silicate sand without or with additives.

In accordance with a further aspect of the present disclosure, a pulper, blender, high speed mixer, or other mixing equipment is used to mix the cement, silicate sand, water, and additives to obtain the second slurry.

In a further embodiment of the present disclosure, there is provided the method herein described, wherein the well mixed slurry of raw materials is subjected to a filtering dewatering manufacturing process.

In accordance with another aspect of the present disclosure, there is provided the method herein described, wherein the aqueous slurry comprising CF and/or CF-containing pulp without or with pulp fibers and/or synthetic fibers, cement, silicate sand and additives, which can be filtered through a screen.

In accordance with yet another aspect of the present disclosure, there is provided the method herein described, wherein a filtration material can be deposited on the screen prior to filtering the aqueous slurry comprising CF, CF-containing pulp, cement, and/or silicate sand and additives through the screen. Preferably, the filtration material can comprise, consist essentially of or consist of filter paper, another fabric material or a combination thereof. More preferably the filtration material can comprise, consist essentially of or consist of another fabric material.

In a further aspect of the present disclosure, there is provided the method herein described, wherein a retention aid agent can be added to the aqueous slurry comprising CF, cement, silicate sand and additives prior to filtering the aqueous slurry through the screen.

According to a further embodiment of the present disclosure, there is provided the method herein described, wherein the wet sheets obtained after the filtration step in the methods of the disclosure can be overlapped (i.e. laminated).

In accordance with another aspect of the present disclosure, there is provided the method herein described, wherein the laminated wet CF cement board can be pressed under high pressure conditions at room temperature (˜23° C.).

In a further embodiment of the present disclosure, there is provided the method herein described, wherein the press molded board obtained by pressing the wet mat is hardened at room temperature (˜23° C.) for 12 to 24 hours and then cured in an autoclave. The curing of the CF cement board can comprise curing the wet board in an autoclave at a temperature in the range of 120-180° C., under a pressure around 138 kPa, for 2 to 12 hours before releasing the pressure.

In yet another aspect of the present disclosure, there is provided the method herein described, wherein the curing of the CF cement board can comprise drying the wet board in a conditioned chamber at room temperature (˜23° C.) with 90-100% relative humidity (RH) for up to 28 days, or at room temperature (˜23° C.) and 100% relative humidity for up to 28 days if synthetic fibers are included in the board formulation.

### EXAMPLES

### Example 1. CF Cement Board Prepared Using a William Handsheet Machine

Dispersed CF with dosages of 0-4% (w/w) were utilized to produce a reference fiber cement board and CF cement boards. Sheet thicknesses varied between 0.3 mm and 12 mm. The wet thin sheets were laminated, if needed, and pressed to a desired thickness after the forming step.

No lamination (i.e. overlapping) was applied if the thickness of the wet sheet reached 6 mm. The pressed samples were hardened at room temperature (˜23° C.) under controlled conditions for 24 hours, followed by autoclave curing under pressure and high temperature. The strength of the novel CF cement boards was tested according to ASTM C1185-98a. The reference fiber cement board samples were made with conventional pulp and the strength of the boards tested using the same methods.

### Experimental Details

Preparation of CF cement board model samples on a William handsheet machine.
(a) Materials

CF was made from an NBSK pulp at a conventional refining intensity and at a specific refining energy of about 5000 kWh/t at a consistency of about 30%. Portland cement (Type 10) was purchased in powder form from Lafarge.
(b) Preparation of CF-cement slurry in water

500 g (OD) never-dried CF (˜30% consistency) was dispersed in 6.25 L hot water at 50° C. at 800 rpm for 10 minutes with a Helico pulper. The consistency of the dispersion was 8% and the dispersed CF was diluted to 0.8-1.8% consistency according to the standard procedure described in U.S. Pat. No. 9,051,684. The pulp fibers were disintegrated using the Domtar Disintegration Method according to standard CPPA C.8P and TAPPI T262. 136 g (OD) pulp fibers were added into 7L water in the Domtar pulper at 90° C. and the pulp fibers slurry was disintegrated at 3450 rpm for 3 minutes. The consistency of the disintegrated pulp was then reduced from around 2% to 0.8-1.8% by dilution with water.

145.5 g Portland cement was added into 270.1 g water and well mixed to form a slurry. A known amount of the dispersed pulp fibers, or the dispersed CF and the dispersed pulp fibers was added to the cement slurry. Extra water around 2.6 L were added into the mixture. The mixture of the cement and the dispersed pulp fibers, or the mixture of the cement, dispersed pulp fibers and dispersed CF were mixed for 5 minutes at 1700 rpm using an overhead stirrer to obtain a slurry of pulp fiber cement or CF cement at a consistency of 4% (w/w). The well mixed slurry of pulp fibers and cement, or the well mixed slurry of pulp fibers, CF and cement, was poured into the William handsheet machine. The weight percentages of CF and cellulose fibers in the fiber cement board and CF cement board formulations, and the amounts of CF, cellulose fibers, cement and water used are shown in Table 1.

TABLE 1
Formulations of fiber cement board and CF cement boards
using 92% of cement and 8%^{*} (w/w) of cellulose
fibers (or CF and cellulose fibers).

| Weight percentages | | Cellulose | | Total water |
|---|---|---|---|---|
| of CF and | CF | fibers | Cement | volume |
| cellulose fibers | (g) | (g) | (g) | (g) |
| 0%/8% | 0 | 12.6 | 145.4 | 3792 |
| 2%/6% | 3.2 | 9.5 | 145.4 | 3792 |
| 4%/4% | 6.3 | 6.3 | 145.4 | 3792 |

^{*}The fiber ratio of cement board composites is in the range of 20%, for commercial cement fiber board, the most preferable fiber ratio in the cement composites is around 6-10%, we have chosen 8% of (CF fiber) as the ratio for most of our experiments for comparison reason.

(c) Preparation of CF cement sheet on a William handsheet machine

A fabric sheet was placed over the opened Williams screen. The Williams sheet former was closed and the mixture of the CF cement suspension was poured into the handsheet machine. It was drained by pressing the lever down until no more free water was observed. The Williams sheet deckle was opened to remove the wet CF cement sheet by inserting a metal plate under the fabric sheet.
(d) Overlapping the wet cement sheet

Another fabric sheet was placed on top of the wet CF cement sheet. The wet cement sheet was flipped onto the pressing plate and the metal plate was removed. The fabric that was on top was removed once the next cement sheet was ready to be added. The steps were repeated for additional layers until reaching the desired thickness on top of which a pressing plate was placed.
(e) Pressing the laminated wet CF cement board

The laminated wet CF cement board was placed inside a Wabash press after the lamination. Metal stoppers of 6 mm thickness on each side of the laminated board were placed to obtain a cement board of 6 mm desired thickness. The laminated wet cement board was pressed for 5 min with a pressure of 5 ton. The wet cement board was transferred into a plastic bag and was sealed.
(f) Autoclave curing of the CF cement board

The pressed cement board was kept in the bag at room temperature for 24 to 48 hours before being cured in autoclave.

The hardened CF cement board was cured in an autoclave at a temperature of 120-180° C. at pressure around 138 kPa for 2-3.5 hours, and then remained in the autoclave for 6-8 hours until the pressure was released.

The autoclaved-cured CF cement boards were placed in a conditioning room of 50% relative humidity at 23° C. for at least 28 days.
(g) Results

The properties of the cured reference cellulose fiber cement board and the cured, novel CF cement boards were measured according to ASTM C1185-98a. Before the measurement, the cured cement boards were kept in a conditioning room of 50% relative humidity at 23° C. for at least 4 days according to the standard method. The results of modulus of rupture (MOR) and water absorption were presented in Table 2.

TABLE 2
Properties of the reference fiber cement board (0% CF and 8%
cellulose fibers) and the novel model CF cement boards
without adding sand or any additives in the formulations.

| Weight | | | | Dimensional |
|---|---|---|---|---|
| percentages of | Density of the | | Water | stability |
| CF/cellulose | cement board | MOR | absorption | (volume |
| fibers | (kg/m³) | (MPa) | (%) | change %) |
| 0%/8% | 1301 | 6.74 | 26 | 0.6 |
| 2%/6% | 1281 | 7.23 | 29 | 0.6 |
| 4%/4% | 1286 | 8.48 | 26 | 0.1 |
| SHERA | 1300 | ≥7.00 | ≤35 | ± 6 |
| Board* | | | | |

*SHERA Board is a high quality commercial fiber cement boards

The modulus of rupture (MOR) of the model system of CF cement board without adding aggregate sand or any other additives was improved by 26%, from 6.74 to 8.48 MPa, by replacing 4% of cellulose fibers with CF in the novel formulation. Surprisingly, the water absorption of CF cement board with 4% CF addition was not increased when compared with 8% cellulose fiber cement board, even though CF is well known for its absorbance property. The requirement of commercial cement board on the water absorption rate is 35% (SHERA Board Technical Data). Also unexpectedly, the dimensional stability of CF cement was also improved significantly as shown by a decrease of volume change from 0.6% to 0.1%.

SHERA Boards were used as a control, as other fiber cement boards. SHERA boards contain additives. The prepared board was compared with SHERA's, although the boards prepared as described herein do not contain any additives, only CF or CF-containing pulp. Even without additives, the board prepared as described herein shows higher properties than the SHERA board containing additives in Table 2.

### Example 2. CF Cement Board Made from only CF, Cement and Water Using Vacuum Dewatering Process

### Experimental Details

A vacuum dewatering process (FIG. 2) simulating the Hatschek process was developed to obtain larger size samples. Preparation of the novel CF cement board with only CF, cement and water as ingredients, using the vacuum dewatering equipment is described as follows:
(a) Materials

CF was made from an NBSK pulp at a conventional refining intensity and at a specific refining energy of about 5000 kWh/t at a consistency of about 30%.

Commercially available Portland cement (Type 10) was purchased in powder form from Lafarge.
(b) Preparation of CF cement slurry in water

500 g (OD) never-dried CF (-30% consistency) was dispersed in 6.25 L hot water at 50° C. in a Helico pulper using the same procedure as described in Example 1.

Proper amounts of Portland cement as showed in Table 3 were measured in a bucket. A known amount of water was added into the bucket and it was well mixed with the cement to form a slurry. A known amount of the dispersed CF was added into the cement slurry bucket. The consistency of the slurry was adjusted to 7% by adding an extra amount of water and the 7% consistency slurry was mixed with a high shear mixer at 1700 rpm for 5 minutes to obtain a uniform slurry. The amounts of CF, Portland cement and water for different CF percentages in the formulations are listed in Table 3.
(c) Preparation of CF cement sheet with a vacuum dewatering forming box

A perforated metal plate covered with a satin cloth was placed at the bottom of the sheet former. The cement slurry was poured into the sheet former, drained by vacuum until there was no more free water on top of the wet cement sheet (FIG. 2B). The top box was removed and the wet cement board with the support of the perforated metal plate covered with the satin cloth was taken out from the bottom box. Another satin cloth was placed on top of the wet sheet and the wet cement sheet was flipped onto the pressing plate. The perforated plate was removed and a second pressing plate was placed on top of the wet cement sheet.

This step was repeated if the thin wet cement sheets needed to be laminated. The thin wet cement sheets were overlapped (i.e. laminated) until a desired thickness was reached.

TABLE 3
Formulations of the reference cement board (0% CF) and
the novel CF cement boards (18″ × 18″ width × length)
made of CF, cement and water only.

| Weight | | | Total |
|---|---|---|---|
| percentage | CF | Cement | water |
| of CF | (g) | (g) | volume (kg) |
| 0%^{*} | 0 | 2133 | 28.8 |
| 2% | 42.6 | 2090.4 | 28.8 |
| 4% | 85.2 | 2047.6 | 28.8 |
| 6% | 128 | 2005 | 28.8 |

^{*}Note: attempt to make a cement board with only water and cement powder was not successful using the vacuum dewatering process, the board cracked upon drying.

(d) Pressing the laminated wet CF cement board

The wet cement board was removed from the forming box and it was placed in the Wabash press. Metal stoppers of 6 mm thickness on each side of the wet cement board were placed to obtain a cement board of 6 mm desired thickness. The pressing with a gradual increase of the pressure and the removal of the pressed CF cement board at the end of the pressing were conducted according to the following steps:
i. Pressing the stack for 5 min at 2 ton pressure;
ii. Increasing the pressure by 1 ton increment every 2 min to a maximum of 10 tons;
iii. Increasing the pressure by 2 tons increment every 2 min to a maximum of 20 tons;
iv. Increasing the pressure to 35 tons and pressing at this pressure for 2 mins;
v. Increasing the pressure to 50 tons and pressing at this pressure for 3 mins;
vi. Releasing the pressure, followed by removing the metal plates and the satin cloths, and placing the cement board inside a plastic bag and sealing the bag. The pressed cement board was kept in the bag at room temperature for 7 days before being cured in autoclave.
(e) Autoclave curing the CF cement board.

The hardened CF cement board was cured in an autoclave at a temperature of 120-180° C. at around 138 kPa for 2-3.5 hours, and then remained in the autoclave for 6-8 hours until the pressure was released.

The autoclaved-cured CF cement boards were placed in a conditioning room of 50% relative humidity at 23° C. for at least 21 days.
(f) Results

The properties of the cured CF cement boards were measured according to ASTM C1185-98a. Before the measurement, the cured cement boards were kept in a conditioning room of 50% relative humidity at 23° C. for at least 4 days according to the standard method. The properties of 0% CF reference sample are not available because the weak board cracked into many pieces upon drying.

Table 4 shows the results of CF cement board made with CF, cement and water only. The modulus of rupture (MOR) of the CF cement board increased with the CF ratio. The MOR of CF cement board with 6% CF is 60% higher than cement board with 2% CF in the formulation. FIG. 1C shows the CF cement board have much more bonding points which explain why the CF cement board showed higher mechanic strength. The water absorption of CF cement board increased with CF ratio, but the value is comparable with cellulose fiber cement board.

TABLE 4
Properties of the reference fiber cement board (0%-6% CF) and the
novel model CF cement boards without adding sand
or any additives in the formulations.

| Weigh | | Modulus | |
|---|---|---|---|
| percentage | Density | of rupture | Water |
| of CF | (kg/m³) | (MOR), MPa | absorption % |
| 0%^{*} | — | — | — |
| 2% | 1660 | 7.1 | 22.1 |
| 4% | 1581 | 10.1 | 26.4 |
| 6% | 1474 | 11.4 | 28.1 |

^{*}Note: attempt to make cement board with only water and cement powder was not successful using the dewatering process, the board crashed once it is dried, thus no properties could be measured.

### Example 3. CF Cement Board Made from CF, Cement, Sand (˜38 wt %) and Water

### Experimental Details

The preparation the novel CF cement board from CF, cement and sand using the vacuum dewatering process is the same as that described in Example 2 except ˜38% of the cement was replaced with sand in the formulation (Table 4) to reduce the raw materials cost.
(a) Materials

CF was the same as that in Example 1. Commercially available Portland cement (Type 10) was purchased in powder form from Lafarge. The ground silicate sand of Sil-co-sil 52, Sil-co-sil 75 and Sil-co-sil 90 were purchased from US Silica Co.
(b) Preparation of CF cement slurry in water

500 g (OD) never-dried CF (˜30% consistency) was dispersed in 6.25 L hot water at 50° C. and 800 rpm for 10 minutes in a Helico pulper as described in Example 1.

Proper amounts of Portland cement (1216 g) and silicate sand (746 g) at a constant 38% sand content in the cement and sand mixture for all the formulations were measured and well mixed in a bucket. A known amount of water was added into the bucket and it was well mixed with the cement and sand to form a slurry. A known amount of dispersed CF was added into the cement and sand slurry bucket. The consistency of the slurry was adjusted to 7% by adding extra amount of water and it was mixed with a high shear mixer at 1700 rpm for 5 minutes to obtain a uniform slurry. The weight percentages of CF and the amounts of CF, Portland cement and sand were listed in Table 5.
(c) Preparation of CF/cement/sand sheet with a vacuum dewatering forming box

The preparation of CF/cement/sand wet sheet was the same as described in Example 2. The wet cement board was formed directly in the vacuum form with enough materials to reach the desired thickness.

TABLE 5
Formulations of the CF reinforced cement board (0% CF) and
the novel CF cement boards (18″ × 18″ width × length)
containing aggregates (~38% sand).

| Weight | | | | Total |
|---|---|---|---|---|
| percentage | CF | Cement | Sand | water |
| of CF | (g) | (g) | (g) | volume (kg) |
| 0.27% | 5.3 | 1216 | 746 | 29.0 |
| 1.07% | 21.3 | 1216 | 746 | 29.0 |
| 2.13% | 42.7 | 1216 | 746 | 29.0 |
| 3.16% | 64 | 1216 | 746 | 29.0 |
| 4.17% | 85.3 | 1216 | 746 | 29.0 |

(d) Pressing the laminated wet cement board

The wet cement board was removed from the forming box and it was placed in the Wabash press. Metal stoppers of 6 mm thickness on each side of the wet cement board were placed to obtain a cement board of 6 mm desired thickness. The pressing and the removal of the pressed CF cement board at the end of the pressing were conducted in the same way as that described in Example 2.
(e) Autoclave curing the CF cement board

The pressed cement board was kept in the plastic bag at room temperature for 7 days before being cured in autoclave.

The hardened CF cement board was cured in an autoclave at a temperature of 120-180° C. at around 138 kPa for 2-3.5 hours, and then remained in the autoclave for 6-8 hours until the pressure was released. The autoclaved-cured CF cement boards were placed in a conditioning room of 50% relative humidity at 23° C. for at least 21 days.
(f) Results

The properties of the cured novel CF cement boards were measured according to ASTM C1185-98a. Before the measurement, the cured cement boards were kept in a conditioning room of 50% relative humidity at 23° C. for at least 4 days according to the standard method. The results of the CF cement boards contain 38% sand in the cement and sand mixture is presented in Table 6. The modulus of rupture (MOR) of the CF cement board containing the silicate sand in the cement board formulation increased with the increase of CF from 0.27 to 2.13% after which the MOR reached a plateau.

TABLE 6
Properties of the novel CF cement boards containing ~38% silicate
sand in the cement and silicate mixture and various
percentages of CF in the cement boards.

| Weigh | | Modulus | Water |
|---|---|---|---|
| percentage | Density | of rupture | absorption |
| of CF | (kg/m³) | (MOR), MPa | % |
| 0.27% | 1549 | 4.2 | 17 |
| 1.07% | 1595 | 9.1 | 28 |
| 2.13% | 1448 | 10.65 | 23 |
| 3.16% | 1370 | 10.44 | 35 |
| 4.17% | 1325 | 10.51 | 36 |

### Example 4. CF Cement Board Made of CF, Cement, Sand (up to 50.6 wt %) and Water

### Experimental Details

Preparation the novel CF cement board using CF, cement and sand with vacuum dewatering process is the same as described in Example 3, where around 50.6 wt % sand was added into the formulation to replace part of the cement to reduce the raw materials cost.
(a) Materials

CF was the same as in Example 1. Commercially available Portland cement (Type 10) was purchased in powder form from Lafarge. The ground silicate sand of Sil-co-sil 52, Sil-co-sil 75 and Sil-co-sil 90 were purchased from US Silica Co.
(b) Preparation of CF cement slurry in water

The preparation of CF cement slurry is exactly same as in Example 3, only the sand ratio of the formulations is different and it is listed in Table 7.
(c) Preparation of CF/cement/sand sheet with a vacuum dewatering forming box

The preparation of CF cement/sand sheet with vacuum dewatering forming box is exactly same as in Example 3.

TABLE 7
Formulations of the CF reinforced cement board (0% CF) and
the novel CF cement boards (18″ × 18″ width × length)
containing aggregates (50.6% sand)

| Weight | | | | Total |
|---|---|---|---|---|
| percentage | CF | Cement | Sand | water |
| of CF | (g) | (g) | (g) | volume (kg) |
| 0% | 0 | 959.9 | 1173.2 | 28.9 |
| 2% | 42.6 | 940.7 | 1149.7 | 28.9 |
| 4% | 85.4 | 921.5 | 1126.2 | 28.9 |
| 6% | 128 | 902.3 | 1102.8 | 28.9 |

The pressing, drying and results measurement steps are same as in Example 3. The results of the novel CF cement boards containing 50.6% (wt) silicate sand in the cement board formulation is presented in Table 8.

TABLE 8
Properties of the novel CF cement boards containing 50.6% (wt)
silicate sand in the cement board formulation

| Weigh | | Modulus | Water |
|---|---|---|---|
| percentage | Density | of rupture | absorption |
| of CF | (kg/m³) | (MOR), MPa | % |
| 0% | — | — | — |
| 2% | 1513 | 7.3 | 29.7 |
| 4% | 1376 | 8.0 | 35.3 |
| 6% | 1274 | 8.8 | 38.7 |

### Example 5. CF Cement Board Made from CF, Pulp Fibers, Cement and 50.6 wt % Percentage of Sand

### Experimental Details

Preparation of the reference fiber cement board and the novel CF cement board with pulp fibers, CF, cement and a high percentage of sand (50.6 wt %) using a vacuum dewatering equipment is described as follows:
(a) Materials

CF was made from an NBSK pulp at a conventional refining intensity and at a specific refining energy of about 5000 kWh/t at a consistency of about 30% as described in Examples 1-3.

Commercially available Portland cement (Type 10) was purchased in powder form from Lafarge. The ground silicate sand of Sil-co-sil 52, Sil-co-si175 and Sil-co-si190 were purchased from US Silica Co.
(b) Preparation of CF cement slurry in water

500 g (OD) never-dried CF (˜30% consistency) was dispersed in 6.25 L hot water at 50° C. and 800 rpm for 10 minutes with a Helico pulper and diluted as described in Examples 1-3. The pulp fibers were disintegrated using the Domtar Disintegration Method according to standard CPPA C.8 P and TAPPI T262. 136 g (OD) pulp fibers were added into 7 L in the Domtar pulper at 90° C. and the pulp fibers slurry was disintegrated at 3450 rpm for 3 minutes. The consistency of the disintegrated pulp was then reduced from around 2% to 0.8-1.8% by dilution with water.

Proper amounts of Portland cement (882 g) and silicate sand (1080 g) at a constant 50.6% silicate sand in the cement and silicate sand mixture were measured and well mixed in a bucket. The high percentage of the silicate sand used to replace the cement was to reduce the raw materials cost. The percentage of the silicate sand in the reference fiber cement board or the novel CF cement boards was 50.6 wt %. A known amount of water was added into the bucket and it was well mixed with the cement and sand to form a slurry. A known amount of the dispersed pulp fibers, or the dispersed CF and the dispersed pulp fibers were added into the cement and sand slurry bucket. The consistency of the slurry was adjusted to 7% by adding extra amount of water and it was mixed with a high shear mixer at 1700 rpm for 5 minutes to obtain a uniform slurry. The weight percentages of CF and cellulose fibers, and the amounts of CF, cellulose fibers, Portland cement and the silicate sand were listed in Table 9.
(c) Preparation of CF cement board with high percentage of sand with a vacuum dewatering process

The same procedure as that used in Examples 2 and 3 was employed to prepare the CF cement board with high percentage of silicate sand.

TABLE 9
Formulations of the reference fiber cement board (0% CF) and
the novel CF cement boards (18″ × 18″ width × length)
containing high percentage of silicate sand

| Weight | | | | | Total |
|---|---|---|---|---|---|
| percentage of | | | | | water |
| CF/cellulose | CF | Cellulose | Cement | Sand | volume |
| fibers | (g) | Fibers (g) | (g) | (g) | (kg) |
| 0%/8% | 0 | 170.6 | 882 | 1080 | 27.56 |
| 2%/6% | 42.6 | 128 | 882 | 1080 | 27.56 |
| 4%/4% | 85.2 | 85.2 | 882 | 1080 | 27.56 |

(d) Pressing the laminated wet cement board

The wet CF cement board was removed from the forming box and it was placed in the Wabash press. Metal stoppers of 6 mm thickness on each side of the wet cement board were placed to obtain a cement board of 6 mm desired thickness. The pressing and the removal of the pressed CF cement board at the end of the pressing were conducted in the same way as that described in Examples 2 and 3.
(e) Autoclave curing the CF cement board
The pressed cement board was kept in the plastic bag at room temperature for 7 days before being cured in autoclave.

The hardened CF cement board was cured in an autoclave at a temperature of 120-180° C. at around 138 kPa for 2-3.5 hours, and then remained in the autoclave for 6-8 hours until the pressure was released. The autoclaved-cured CF cement boards were placed in a conditioning room of 50% relative humidity at 23° C. for at least 21 days.
(f) Results

The properties of the cured reference fiber cement board and the novel CF cement boards were measured according to ASTM C1185-98a. Before the measurement, the cured cement boards were kept in a conditioning room of 50% relative humidity at 23° C. for at least 4 days according to the standard method. The formulation of 8% pulp fiber was utilized as reference samples to simulate commercial fiber cement board composite products without any additives. Surprisingly, the modulus of rupture (MOR) of the fiber cement board that contained 50.6 wt % of silicate sand in the cement board formulation was significantly increased by 91%, passing from 4.3 to 8.2 MPa by replacing 2% (w/w) of cellulose fibers in the cement board formulation with 2% (w/w) of CF (Table 10). The modulus of elasticity (MOE) was also significantly improved with the replacement of the 2 wt % of cellulose fibers with CF for the cement board (Table 10). Surprisingly, it was observed that the presence of CF had a significant impact on the improvement of the mechanical strength property, especially the modulus of rupture for the formulation with a high percentage of silicate sand. The significant mechanical strength property improvement with addition CF can be explained from FIGS. 1B and 1C, where the CF contributes much more bonding points and shows better bonding strength among CF, CF and cellulose fiber, CF and cement and sand particles. These are highly desirable characters for the cement board industry because the use of high percentage of sand is a common practice in the fiber cement board industry. Consistently, the water absorption remains at the similar level compared with the previous observation.

TABLE 10
Properties of the reference fiber cement board (0% CF) and the novel CF cement
boards containing 50.6% (wt) silicate sand in the cement board formulation

| | | Modulus of rupture (MOR) | | Modulus of elasticity (MOE) | | Water |
|---|---|---|---|---|---|---|
| Weigh percentage of | Density | | Improvement | | Improvement | absorption |
| CF/cellulose fibers | kg/m³ | MPa | (%) | MPa | (%) | % |
| 0%/8% | 1366 | 4.3 | — | 4003 | | 38% |
| 2%/6% | 1336 | 8.2 | 91% | 4665 | 16% | 35% |
| 4%/4% | 1317 | 8.4 | 95% | 4903 | 23% | 38% |

### Example 6 Preparation of CF Cement Board with Addition of Synthetic Fibers Using Vacuum Dewatering Process

### Experimental Details

(a) Materials

CF, cellulose fibers, cement and sand were the same as those used in Example 4. PVA (Polyvinyl alcohol) fibers (Kuralon VPB041) with 6 μm in diameter, 3 mm in length was obtained from Engineered Fibers Technology LLC.
(b) Preparation of CF cement slurry in water

The dispersion procedure of CF and pulp fibers was the same as that described in Examples 2 and 4.

21.3 g PVA fibers was added into 2 L of water and stirred with an overhead stirrer for 5 min at 1000 rpm. Proper amounts of Portland cement and silicate sand were measured and well mixed in a bucket. Up to 55% (wt) of the sand was added into the cement and silicate formulation. The amount of the sand in the reference cement board or the novel CF cement boards was 51.2 wt %. The dispersed pulp fibers, dispersed CF and dispersed PVA fibers were added into the cement and silicate sand slurry. Additional dilution water was added to the slurry to obtain the desired consistency. The mixture of the dilute slurry was mixed for 5 min at 1700 rpm using an overhead stirrer. Table 11 shows exemplary formulations of a reference fiber cement board (0% CF) and the novel CF fiber cement boards (18″×18″ width×length) that also contain the silicate sand and the PVA fibers.

TABLE 11
Formulations of a reference fiber cement board and the novel
CF cement boards that also contain sand and PVA fibers.

| | | Cellulose | PVA | | | Total |
|---|---|---|---|---|---|---|
| Weight percentage of | CF | fibers | fibers | Cement | Sand | water volume |
| CF/cellulose fibers | (g) | (g) | (g) | (g) | (g) | (kg) |
| 0%/5% | 0 | 106.6 | 42.6 | 892.6 | 1091 | 28.8 |
| 2%/3% | 42.6 | 64 | 42.6 | 892.6 | 1091 | 28.8 |
| 4%/1% | 85.4 | 21.3 | 42.6 | 892.6 | 1091 | 28.8 |
| 5%/0% | 106.6 | 0 | 42.6 | 892.6 | 1091 | 28.8 |

(c) Preparation of the cement sheet with a vacuum dewatering forming box

The mixture was poured into the sheet former and was drained by vacuum until no more free water was observed. The top box was removed and the wet cement sheet was taken out from the bottom box. A satin cloth was put on top of the wet cement board and it was flipped onto the pressing plate. The perforated plate was removed and the second pressing plate was put on top of the wet cement board.
(d) Pressing the laminated cement board

These type of wet cement board could be dried/cured directly without pressing at the wet stage. However in this experiment, the wet cement boards were pressed and dried/cured following the procedure below.

The wet cement board was removed from the forming box and placed in the Wabash press. Metal stoppers of 6 mm thickness on each side of the wet cement board were placed to obtain a cement board of 6 mm. The pressing with a gradual increase of the pressure and the removal of the pressed CF cement board at the end of the pressing were conducted in the same manner as that described in Example 2.
(e) Air curing of the cement board

The pressed cement boards were placed and cured in a conditioning room of 95% relative humidity at 23° C. for 28 days.
(f) Results

The properties of the cured cement boards were measured according to ASTM C1185-98a. Before the measurement, the cured cement boards were kept in a conditioning room of 50% relative humidity at 23° C. for at least 4 days according to the standard method. As can be seen from the data in Table 12, significant improvement of the modulus of rupture (MOR) for the fiber cement board was achieved by replacing a portion of the cellulose fibers, with the CF. The significant mechanical strength property improvement with addition CF can be explained from FIG. 1D, where the CF contributes much more bonding points and shows better bonding strength among CF, CF and PVA fibers, CF and cement and sand particles. These are highly desirable characters for the cement board industry because the use of high percentage of sand is a common practice in the fiber cement board industry. Consistently, the water absorption remains at the similar level compared with the previous observation.

TABLE 12
Properties of the reference fiber cement board (0% CF) and the novel
CF cement boards containing 2 (wt) % PVA and 51.2 (wt) % silicate
sand in the cement board formulation

| | | Modulus of rupture | | |
|---|---|---|---|---|
| | | (MOR) | | Water |
| CF/cellulose | PVA | | | absorption |
| fibers | Fiber | MPa | Improvement (%) | % |
| 0%/5% | 2% | 8.1 | — | 31% |
| 2%/3% | 2% | 11.3 | 34% | 32% |
| 4%/1% | 2% | 10.6 | 31% | 35% |
| 5%/0% | 2% | 11.6 | 43% | 37% |

### Example 7. Interaction of CF and Additives to Produce Cement Board Using Vacuum Dewatering Process

### Experimental Details.

(a) Materials

CF, cement and sand were the same as those used in Example 4. PVA (Polyvinyl alcohol) granules (Elvanol 71-30) was obtained fromKuraray America Inc..
(b) Preparation of CF cement slurry in water

The dispersion procedure of CF and pulp fibers was the same as that described in Examples 2 and 4.

Proper amounts of Portland cement, silicate sand and PVA granules were measured and well mixed in a bucket. Up to 55% (wt) of the sand was added into the formulation. The amount of the sand in the reference cement board or the novel CF cement boards was 51.2 wt %. The dispersed CF was added into the cement, silicate sand, and PVA slurry. Additional dilution water was added to the slurry to obtain the desired consistency. The mixture of the dilute slurry was mixed for 5 min at 1700 rpm using an overhead stirrer. Table 13 shows exemplary formulations of a reference fiber cement board (0% CF) and the novel CF fiber cement boards (18″×18″ width×length) that also contain the silicate sand and the PVA, where the CF ratio was maintained at 2%, while PVA ratio changed from 0%, 1%, 2% and 3%. The pressing procedure of CF/PVA cement board is the same as examples 2 to 6 described. The pressed boards were placed in conditioning room at 95% relative humidity and 23° C. and were cured as Example 6 in step e described. The mechanical properties of the samples were measured as described in all examples. The results are presented in Table 14.

TABLE 13
Formulation of CF cement board contain sand and PVA, which shows
the interaction between CF and PVA at different ratio.

| | | Cellulose | | | | Total |
|---|---|---|---|---|---|---|
| Weight percentage of | CF | fibers | PVA | Cement | Sand | water volume |
| CF/cellulose fibers | (g) | (g) | (g) | (g) | (g) | (kg) |
| 2%/0% | 0 | 0 | 0 | 941 | 1150 | 28.8 |
| 2%/0% | 42.7 | 0 | 21.3 | 931 | 1138 | 28.8 |
| 2%/0% | 42.7 | 0 | 42.7 | 922 | 1126 | 28.8 |
| 2%/0% | 42.7 | 0 | 64 | 912 | 1115 | 28.8 |

TABLE 14
Properties of the reference fiber cement board (0% CF) and the novel
CF cement boards containing 2 (wt) % PVA and 51.2 (wt) %
silicate sand in the cement board formulation

| | | Modulus of rupture | | Water absorption | |
|---|---|---|---|---|---|
| | | (MOR) | | (2hrs | |
| CF | | | Improvement | immersion) | Moisture |
| % | PVA | MPa | (%) | % | (%) |
| 2% | 0% | 6.96 | — | 29 | 5.7 |
| 2% | 1% | 8.20 | 18% | 30 | 5.5 |
| 2% | 2% | 11.0 | 58% | 32 | 5.3 |
| 2% | 3% | 11.0 | 58% | 30 | 5.4 |
| USG | — | 9.35 | — | 50 | 16.4 |
| Fiberock | | | | | |

While the present disclosure has been described in connection with specific embodiments thereof, it will be understood that it is capable of further modifications and this application is intended to cover any variations, uses, or adaptations, as come within known or customary practice within the art and as may be applied to the essential features hereinbefore set forth, and as follows in the scope of the appended claims.

1. A cellulose filament (C) cement composite board comprising:
CF and/or CF-containing pulp, and
cement,
wherein the CF has an aspect ratio of 200 to 5000,
comprising a weight % of CF is from 0.01% to 20% by weight of the composite board.

2. The CF cement composite board of claim 1, comprising CF.

3. The CF cement composite board of claim 1, comprising CF-containing pulp.

4. The CF cement composite board of claim 1, wherein the CF has a width from 30 nm to 500 nm.

5. The CF cement composite board of claim 1, wherein the weight % of CF is from 0.27 to 1.07% by weight of the composite board.

6. (canceled)

7. The CF cement composite board of claim 1, wherein the CF is at least one of a free of chemicals form, a free of chemical modification form, a free of derivatization form.

8. The CF cement composite board of claim 1, wherein the CF are dry cellulose filaments that are re-dispersible in water.

9. The CF cement composite board of claim 8, wherein the dry cellulose filaments are at least 80% by weight solids.

10. The CF cement composite board of claim 9, wherein the dry cellulose filaments are at least one of a dry lap, flakes or particles.

11. The CF cement composite board of claim 1, wherein the CF and/or CF-containing pulp are selected from the group consisting of CF and/or CF-containing pulp in a never-dried wet state, in an aqueous slurry and mixtures thereof.

12. The CF cement composite board of claim 1, further comprising cellulose fibers and/or synthetic fibers.

13-21. (canceled)

22. A method for preparing the cellulose filament (CF) cement board of claim 1, the method comprising the steps of:
a) forming an aqueous slurry comprising CF, and/or CF-containing pulp, cement, and water;
b) filtering the aqueous slurry to form a thick panel;
c) pressing the wet panel to a desired shape and/or form; and
d) autoclave-curing the pressed CF cement board.

23. The method of claim 22, wherein the slurry further comprises at least one of pulp fibers, synthetic fibers, sand, and additives.

24. The method of claims 23, wherein the pressed CF cement board comprising synthetic fibers is air-cured.

25. The method of claim 22, wherein the wet panel is pressed in a molded mat.

26. The method of claim 25, wherein the molded mat is hardened at room temperature for 24 hours and cured in an autoclave.

27. The method of claim 22, when the autoclave-curing is at a temperature of about 120-180° C.

28. The method of claim 22, further comprises drying the wet pressed panel in a conditioned room at room temperature and 90-100% relative humidity (RH) for up to 28 days.

29. The method of claim 22, wherein the CF has a width from 30 nm to 500 nm.
